(19) United States
(12) Patent Application Publication
(10) Pub. No.: US 2021/0142423 A1
(43) Pub. Date: May 13, 2021

(54) Trip Classifying Devices, Systems and Methods

(71) Applicant: Taxbot LLC, Layton, UT (US)

(72) Inventors: Jacob Thomas Randall, Layton, UT (US); David Robert Gourley, Kaysville, UT (US); Benjamin Zeeman, Bountiful, UT (US); Zac Johnson, Logan, UT (US); Dustin Huntsman, Providence, UT (US); Daniel Blaine Ostler, Providence, UT (US); Trevor Phillips, Ogden, UT (US); Johnathan Heiner, Mesa, AZ (US); Justin Smith, Kaysville, UT (US); Bonnie Randall, Layton, UT (US); Shane Thompson, Clarkston, UT (US)

(73) Assignee: Taxbot LLC, Layton, UT (US)

(21) Appl. No.: 16/949,350

(22) Filed: Oct. 26, 2020

Related U.S. Application Data
(60) Provisional application No. 62/926,460, filed on Oct. 26, 2019.

(51) Int. Cl. G06Q 40/00

(52) U.S. Cl. CPC G06Q 40/123; G06F 3/167

(57) ABSTRACT

Trip classifying systems and methods include one or more servers communicatively coupled with a mobile device, one or more data stores, and a trip classifying device. The trip classifying device includes a housing, a processor, a wireless communication module, a speaker, a business selector, a personal selector, and a microphone. In response to a signal received from a mobile phone indicating that the trip has begun, the trip classifying device provides a notification to the driver to classify the trip. In response to receiving the user selection of the business selector, the system automatically initiates an audio recording for the driver to dictate a business purpose for the trip. The audio recording is transmitted to the mobile phone which initiates transcription and later displays the transcription on a user interface of the mobile phone. The trip classifying device may have no trip classifying selectors except the business and personal selectors.

### CROSS REFERENCE TO RELATED APPLICATIONS

This document claims the benefit of the filing date of U.S. Provisional Patent Application No. 62/926,460, entitled “Trip Classifying Devices, System and Methods,” naming as first inventor Jacob Thomas Randall, which was filed on Oct. 26, 2019, the disclosure of which is hereby incorporated entirely herein by reference.

### BACKGROUND

### 1. Technical Field

Aspects of this document relate generally to devices, system and methods for classification of trips as either personal trips or business trips for tax purposes.

### 2. Background Art

Tax laws in the United States and elsewhere allow for business trips and related expenses to reduce taxable income or otherwise reduce a tax burden on a business. Prior art systems and methods provide for prompting a user to choose a trip classification (as either personal or business) during a trip. Prior art systems and methods further allow for the recording of a trip purpose. Some prior art systems connect with a vehicle's On-Board Diagnostics (OBD) port to determine accurate mileage of trips and to allow the user to classify between personal and business trips. Other prior art systems determine mileage using GPS coordinates of starting and ending locations.

### SUMMARY

Implementations of trip classifying devices may include: a housing; a processor located at least partly within the housing; a wireless communication module located at least partly within the housing and communicatively coupled with the processor, the wireless communication module being configured to receive a signal, from a mobile device communicatively coupled with the wireless communication module, indicating that a trip has begun; a speaker located at least partly within the housing and configured to, in response to the signal being received by the wireless communication module, provide an audio notification to a driver of a vehicle reminding the driver to classify the trip; a business selector configured to receive a user selection classifying the trip as a business trip; a personal selector configured to receive a user selection classifying the trip as a personal trip; and a microphone located at least partly within the housing and communicatively coupled with the processor; the trip classifying device may include no trip classifying selectors other than the business selector and the personal selector; the trip classifying device may have either zero indicator lights or only one indicator light; the trip classifying device may have no electronic display; the trip classifying device may be configured to, in response to receiving the user selection of the business selector, automatically initiate an audio recording, using the microphone, for a predetermined amount of time, for the driver to dictate a business purpose for the trip; and the trip classifying device may be configured to transmit the audio recording to the mobile device, for transcription of the audio recording by the mobile device.

Implementations of trip classifying devices may include one or more or all of the following:

The trip classifying device may have only one indicator light, the only one indicator light being a classification reminder indicator light configured to provide a visual notification reminding the driver to classify the trip as a personal trip or a business trip.

The trip classifying device may have only one indicator light, the only one indicator light being a recording indicator light configured to provide a visual notification to the driver when audio is being recorded.

The trip classifying device may have zero indicator lights.

The trip classifying device may be configured to not initiate an audio recording except in response to the user selection of the business selector classifying the trip as a business trip.

The trip classifying device may not include a selector configured to manually stop the audio recording.

The trip classifying device may not include a global positioning system (GPS) sensor.

The trip classifying device may provide no visual indication of whether the trip has been classified as a business trip or a personal trip.

The trip classifying device may not be configured to play back the audio recording.

The business selector may not be configured to be modified to classify the trip as anything other than a business trip.

The personal selector may not be configured to be modified to classify the trip as anything other than a personal trip.

Implementations of trip classifying systems may include: one or more servers communicatively coupled with a mobile phone through a telecommunication network; one or more data stores communicatively coupled with the one or more servers; a trip classifying device communicatively coupled with the mobile phone, the trip classifying device including: a housing; a processor located at least partly within the housing; a wireless communication module located at least partly within the housing and communicatively coupled with the processor, the wireless communication module configured to receive a signal, from the mobile phone, indicating that a trip has begun; a speaker located at least partly within the housing and configured to, in response to the signal being received by the wireless communication module, provide an audio notification to a driver of a vehicle reminding the driver to classify the trip; a business selector configured to receive a user selection classifying the trip as a business trip; a personal selector configured to receive a user selection classifying the trip as a personal trip; and a microphone located at least partly within the housing and communicatively coupled with the processor; the trip classifying device may have no trip classifying selectors other than the business selector and the personal selector; the trip classifying device may have no electronic display; the trip classifying device may be configured to, in response to receiving the user selection of the business selector, automatically initiate an audio recording, using the microphone, for a predetermined amount of time, for the driver to dictate a business purpose for the trip; the trip classifying device may be configured to transmit the audio recording to the mobile phone for the mobile phone to transcribe the audio recording; and the one or more servers may be configured to provide one or more user interfaces to be displayed on the mobile phone, the one or more user interfaces displaying a transcription of the audio recording.

Implementations of trip classifying systems may include one or more or all of the following:

A coupler may be coupled with the housing and may be configured to attach the trip classifying device to a portion of the vehicle (such as the visor, the dash, etc.).

The personal selector may be a first color and the business selector may be a second color different than the first color.

Implementations of trip classifying methods may include: providing one or more servers; providing one or more data stores communicatively coupled with the one or more servers; providing one or more user interfaces to be displayed on a mobile phone communicatively coupled, through a telecommunication network, with the one or more servers; providing a trip classifying device configured to communicatively couple with the mobile phone, the trip classifying device including: a housing; a processor located at least partly within the housing; a wireless communication module located at least partly within the housing and communicatively coupled with the processor; a speaker located at least partly within the housing; a business selector configured to receive a user selection classifying a trip as a business trip; a personal selector configured to receive a user selection classifying the trip as a personal trip; and a microphone located at least partly within the housing and communicatively coupled with the processor; receiving a signal, at the wireless communication module, from the mobile phone, indicating that the trip has begun; in response to receiving the signal at the wireless communication module, providing, using the trip classifying device, a visual notification and/or an audio notification to a driver of a vehicle, reminding the driver to classify the trip; in response to receiving the user selection of the business selector, automatically initiating, with the processor and using the microphone, an audio recording, for a predetermined amount of time, for the driver to dictate a business purpose for the trip; transmitting the audio recording to the mobile phone; using a software application installed on the mobile phone, initiating transcription of the audio recording; and displaying, on the one or more user interfaces, a transcription of the audio recording.

Implementations of trip classifying methods may include one or more or all of the following:

In response to receiving the user selection of the personal selector, not initiating an audio recording.

The trip classifying device may have no trip classifying selectors other than the business selector and the personal selector.

The trip classifying device may have either zero indicator lights or only one indicator light.

The trip classifying device may have no electronic display.

The predetermined amount of time may be less than 20 seconds.

The steps of receiving the signal at the wireless communication module from the mobile phone, transmitting the audio recording to the mobile phone, and initiating transcription of the audio recording, may not require user interaction with the mobile phone.

The method may include storing the transcription in a memory of the mobile phone and/or in the one or more data stores. The step of storing the transcription may not require user interaction with the mobile phone.

The method may further include storing a mileage of the trip, a starting location of the trip, an ending location of the trip, and a date of the trip, in a memory of the mobile phone and/or in the one or more data stores. The steps of storing the mileage, the starting location, the ending location, and the date may not require user interaction with the mobile phone.

General details of the above-described implementations, and other implementations, are given below in the DESCRIPTION, the DRAWINGS, and the CLAIMS.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1A is a diagram of a trip classifying system;

FIG. 1B is a block diagram representatively illustrating elements of a trip classifying device of the trip classifying system of FIG. 1A;

FIG. 2 is a user interface of the system of FIG. 1A;

FIG. 3 is a user interface of the system of FIG. 1A;

FIG. 4 is a user interface of the system of FIG. 1A;

FIG. 5 is a user interface of the system of FIG. 1A;

FIG. 6 is a user interface of the system of FIG. 1A;

FIG. 7 is a user interface of the system of FIG. 1A;

FIG. 8 is a user interface of the system of FIG. 1A;

FIG. 9 is a user interface of the system of FIG. 1A;

FIG. 10 is a user interface of the system of FIG. 1A;

FIG. 11 is a user interface of the system of FIG. 1A;

FIG. 12 is a user interface of the system of FIG. 1A;

FIG. 13 is a user interface of the system of FIG. 1A;

FIG. 14 is a user interface of the system of FIG. 1A;

FIG. 15 is a user interface of the system of FIG. 1A;

FIG. 16 is a user interface of the system of FIG. 1A;

FIG. 17 is a user interface of the system of FIG. 1A;

FIG. 18 is a user interface of the system of FIG. 1A;

FIG. 19 is a user interface of the system of FIG. 1A;

FIG. 20 is a user interface of the system of FIG. 1A;

FIG. 21 is a user interface of the system of FIG. 1A;

FIG. 22 is a user interface of the system of FIG. 1A;

FIG. 23 is a user interface of the system of FIG. 1A;

FIG. 24 is a user interface of the system of FIG. 1A;

FIG. 25 is a user interface of the system of FIG. 1A;

FIG. 26 is a user interface of the system of FIG. 1A;

FIG. 27 is a user interface of the system of FIG. 1A;

FIG. 28 is a user interface of the system of FIG. 1A;

FIG. 29 is a user interface of the system of FIG. 1A;

FIG. 30 is a user interface of the system of FIG. 1A;

FIG. 31 is a user interface of the system of FIG. 1A;

FIG. 32 is a user interface of the system of FIG. 1A;

FIG. 33 is a user interface of the system of FIG. 1A;

FIG. 34 is a user interface of the system of FIG. 1A;

FIG. 35 is a user interface of the system of FIG. 1A;

FIG. 36 is a user interface of the system of FIG. 1A;

FIG. 37 is a user interface of the system of FIG. 1A;

FIG. 38 is a user interface of the system of FIG. 1A;

FIG. 39 is a user interface of the system of FIG. 1A;

FIG. 40 is a user interface of the system of FIG. 1A;

FIG. 41 is a user interface of the system of FIG. 1A;

FIG. 42 is a user interface of the system of FIG. 1A;

FIG. 43 is a user interface of the system of FIG. 1A;

FIG. 44 is a user interface of the system of FIG. 1A;

FIG. 45 is a user interface of the system of FIG. 1A;

FIG. 46 is a user interface of the system of FIG. 1A;

FIG. 47 is a user interface of the system of FIG. 1A; and

FIG. 48 is a block diagram representatively illustrating a method of trip classification using the system of FIG. 1A.

### DESCRIPTION

Implementations/embodiments disclosed herein (including those not expressly discussed in detail) are not limited to the particular components or procedures described herein. Additional or alternative components, assembly procedures, and/or methods of use consistent with the intended trip classifying devices, systems and methods may be utilized in any implementation. This may include any materials, components, sub-components, methods, sub-methods, steps, and so forth.

Referring to FIG. 1A, a representative example of a trip classifying system (system) 100 is shown. System 100 is just one example among many that could be used to implement the methods disclosed herein. System 100 includes one or more elements 102 which handle the back end of trip classifying methods. In FIG. 1 the elements 102 may include one or more servers 104, one or more data store servers (or database servers) 106 coupled with one or more data stores (which may include one or more databases 108), one or more web servers 110, one or more application (app) servers 112, and/or one or more server racks, and so forth.

Elements 102 may be communicatively coupled with one another such as through one or more wired connections, one or more wireless connections, a telecommunication network (network) 120 such as, by non-limiting example, the Internet, and so forth. One or more administrator computing devices (device) 116 may be coupled with elements 120 directly (such as through a wired connection) and/or through the telecommunication network 120 or otherwise. Administrator device 116 includes a display 118 whereon, through one or more user interfaces, an administrator may configure various aspects of the elements 102 to carry out the trip classifying methods, such as configuring end user interfaces, setting up database or data store settings, and so forth.

A mobile device 122 (which may be a mobile phone) is shown communicatively coupled to other elements of the system 100 through the telecommunication network 120, which may include Wi-Fi and/or cellular communications.

Trip classifying device (device) 126 is seen communicatively coupled with the mobile device, such as by non-limiting example through a BLUETOOTH connection. In other implementations the two could be coupled using near-field communication (NFC) or another wireless communication protocol, and those given here are just examples. Device 126 is seen to be formed of a housing 128 which, in the implementation shown, is formed of a rigid polymer though in other implementations it could be formed of a metal or other rigid material. A coupler 130 (which in this case is a clip) is included to allow the device to be coupled to a visor of a vehicle. In the case of a clip the coupler may clip the device to the visor. The coupler could alternatively be an elastic band or the like, and may couple the device to the visor by the elastic band circumscribing the visor in a friction fit. A business selector (selector) 132 and a personal selector (selector) 134 are accessible for a user to make selections regarding whether a trip is a business trip or a personal trip. An indicator light 136 and a speaker 138 allow for notifications to be made to a user.

Device 126 may include a number of other elements which are not shown in the drawings. Device 126 may include a printed circuit board (PCB) communicatively coupling together various elements within the housing. For example, the PCB may communicatively couple together a processing chip (processor) (microprocessor), a BLUETOOTH chip and/or NFC chip and/or another communication module/chip, a speaker, one or more indicator lights which may be light emitting diodes (LEDs), a microphone, one or more memory elements such as flash memory, a battery or other power module, and so forth. In other examples one or more of the above elements may be combined together on the PCB. In one representative example an ESP32 system on a chip (SoC) microcontroller, with integrated Wi-Fi and dual mode BLUETOOTH, is coupled with the PCB and is used for the processing and wireless communication capabilities of device 126. Although in this implementation the communication and processing elements exist on the same chip, such an implementation is nevertheless considered to have a processer and a communication module communicatively coupled with the processor, as those terms are used herein.

In implementations the power module includes a rechargeable lithium ion battery that lasts up to one month and recharges in about an hour.

Referring still to FIG. 1A, in implementations the elements 102 may be used to provide trip classifying functionality through a software application, running on device 122, to allow a user to classify trips as business trips or personal trips and to describe the trips. For example, using data store server 106 and/or data store 108 a user's login and other credentials, trip classifications and descriptions, receipt images, etc. may be stored and retrieved by the system as needed. Using app server 112 a software application running on mobile device 122 may interact with the system 100 to facilitate user interaction, such as accessing user information and files stored in the data store, updating user information, storing additional information and files in the data store, viewing and editing profile information, viewing recorded trips and transcribed descriptions and editing them, viewing and editing receipts and receipt descriptions, and so forth. Web server 110 may allow an end user to perform some or all of the same functions, but through a website interface. This may allow the user to have some of the same or similar functionality through a desktop computer or laptop as the user has through the mobile app. Server 104 may be used for processing as needed—for example a user recording may be transmitted from the mobile device through the internet to server 104 to be transcribed and then the transcription may be stored in the data store for later viewing through display 124 and/or stored locally on mobile device 122. One or more server racks 114 or a portion thereof may be used instead of or in addition to server 104, and any of the elements 102 may be scaled to any number as the need arises, such as to accommodate an increasing number of users. Third party servers may be used as well—for instance device 126 may send an audio recording to device 122 and device 122 may in turn send the audio recording to a third party server for transcription (such as using a GOOGLE TRANSLATE service), with the transcription being stored on server 104 and/or 114 and/or on local storage of device 122.

One or more of the elements 102 could be excluded from system 100. For example, a website interface may not be needed in some implementations and so web server 110 may be excluded. Server 104 may be excluded in favor of using one or more server racks or portions thereof, and so forth. Although elements 102 are shown as distinct devices, in a very simple implementation all of the elements 102 could be implemented on the same device, such as through the use of virtualization and/or containerization. In more standard implementations one or more of the elements 102 will be running/implemented on distinct devices, some of which may be located in the same location and/or others of which may be located remotely and communicatively coupled with the other elements 102, and/or with system 100 generally, through network 120.

Device 116 may allow an administrator, through user interfaces displayed on display 118, to configure elements 102. For example the admin may set up a certain device to be a web or application server and another device to be a data store server, remove one of the elements 102 (or remove access to or from one of the elements 102 relative to other elements), add additional elements 102 (or add access to or from one of the elements 102 relative to other elements), configure user interfaces to be displayed on device 122, configure the data store or database, run reports related to users and use of the system, and so forth.

Device 122 may have one or more software applications downloaded and installed thereon (such as downloaded through network 120 from the app server or some other server), which software application may provide user interfaces for the user to access information, store information, edit and delete information, etc., associated with the user through the data store or database. The software application may also provide for automatic functions that facilitate some of the trip classifying methods, as will be discussed hereafter.

In some implementations one or more of elements 102 may be third-party elements that are used by the system—for example one or more databases or servers could be cloud databases or servers (such as AWS servers) such that their associated hardware is located remotely and set up and/or configured to some extent by the third party.

Device 126 may be used in conjunction with device 122 for trip classification. For example, the coupler 130 may be used to couple device 126 to a vehicle visor. The user may have previously linked device 126 and 122 through a BLUETOOTH and/or NFC or other communication protocol connection. The user may have his/her mobile device when beginning a trip in the vehicle and, using the global positioning system (GPS) and/or accelerometer of the mobile device, the software app installed on the device 122 may determine that a trip has begun (and for example may discern the difference between the user walking, bicycling, and taking a trip in a car). The software app, upon determining that a trip has begun, may send one or more signals to device 126 indicating that a trip has begun. This may include a request or code sent to device 126 to execute/initiate one or more processes.

For example, in response to receiving the one or more signals, device 126 may illuminate indicator light 136 to notify the user that the system has detected the beginning of a trip. Through the speaker 138 the device may provide the user with an audio notification that a trip has begun (such as a beep, a chime, a spoken notification, or another sound). The illumination of the indicator light and/or the provision of the audio notification may constitute reminders to the user to classify the trip as either a business trip or a personal trip. The user may, in response, select either the personal (P) or business (B) selector, which will initiate the sending of a signal from device 126 to device 122 to store, locally on device 122 and/or remotely in the data store, an indication that this trip is a personal or business trip. The stored indication, for example, may include a date and time of initiation of the trip, the indication of either “personal” or “business,” the start location and end location (such as GPS coordinates and/or addresses), the vehicle (which may be a default vehicle set up by the user or, for example, the user may have one device 126 per vehicle so that the system determines the vehicle based on which device 126 is nearest to device 122, or the user may select a vehicle using device 126 or 122), and so forth.

If the user selects the business selector then device 126 may, in response, automatically begin an audio recording. This may be indicated by the light lighting up (either the same or different color as previously, and the same or different lighting pattern as previously, such as flashing versus steady, long flashing versus short flashing, etc.). The beginning of recording may also and/or alternatively be indicated by one or more audio notifications to the user such as a beep, tone, spoken notification, and so forth provided using the speaker. After recording begins, the user may speak a description of the business trip, such as “lunch meeting with vendor,” “meeting with real estate attorney,” or the like. In other implementations, there may be no indication provided to the user that the recording has begun but, rather, the recording simply starts automatically when the user presses the business selector.

After a predetermined amount of time, or after the user stops speaking for a predetermined amount of time, device 126 may stop recording and may communicate the recorded audio data/file to device 122 through the BLUETOOTH or other connection. In some implementations device 126 is configured to automatically record for a preset amount of time each time the business selector is used to classify a trip as a business trip. For example, the system may be configured so that, each time a trip is classified as a business trip using the business selector, device 126 records for ten seconds. In other implementations the automatic length of the recording may be for a different amount of time, such as five seconds, fifteen seconds, twenty seconds, twenty-five seconds, thirty seconds, under twenty seconds, under twenty-five seconds, under thirty seconds, and so forth. In implementations the device 126 may be configured to provide an audio and/or visual notification to the user once the recording has stopped or when it is about to stop, for example a flashing indicator light as the recording is nearing its end and/or a beep when the recording has ended, or a steady indicator light once the recording ends. Alternatively, the indicator light could be illuminated once the recording begins and could flash as the recording is nearing its end and then turn off once the recording has ended. Various other options are possible, and the practitioner of ordinary skill in the art will be able to program use of the indicator light and speaker elements to provide appropriate notification to the user.

It is pointed out here that one of the problems with prior art trip classification devices is their complexity with regards to the user interface elements, selectors, indicator lights, and the like. The trip classifying device disclosed herein is used to classify trips while the user is driving. Accordingly, in order to create a simple process for the user, which allows trip classification but does not distract the driver or require the selection of more than one selector, the trip classifying device disclosed in the drawings only includes two selectors (the personal and business selector), includes only one indicator light, and includes no electronic display. For the purposes of this disclosure, simple light emitting diodes (LED) and similar simple light indicators are not considered to be “electronic displays.” In other implementations the indicator light could be omitted entirely, so that there is no indicator light. The use of only two selectors, and only one or zero indicator lights, and no electronic display, allows the driver to not be distracted while driving. In implementations in which there are more than one indicator lights the driver may need to view the light for longer to determine what an illuminated light means. In implementations with more than two selectors the user may need to view the selectors for longer before determining which selector to select. In implementations with electronic displays there may be information displayed on the display that the user needs to review before or while making a selection. In other words, prior art devices which include more than one indicator light, or more than two selectors, or an electronic display, may require the driver to have his/her eyes focused on the device for a longer period of time to properly use the device. This increases the odds of the driver being involved in a vehicle accident and can lead to vehicle damage, injury, and even death. Therefore, the very simple format of the disclosed devices, having only two selectors, only one or zero indicator lights, and no electronic display, decreases the likelihood of vehicle damage, injury, and death. The disclosed methods, systems and devices also allow the user's mobile phone to be used to facilitate the trip classification methods without requiring the user to ever interact with the phone during the trip. This further decreases the odds of the user being in an accident and decreases the odds of vehicle damage, injury and death. It also helps the user to comply with state laws in some jurisdictions, which make it illegal to use a phone while operating a vehicle.

Additionally, the personal and business selectors may be a different color than the rest of the housing and may be a different color from one another. For example the housing may be a grey or black or other muted color, the personal selector may be a bright blue color, and the business selector may be a bright green color. The bright blue and bright green colors may have a high contrast relative to the housing and/or relative to one another. This may make it easier for the user to quickly know which selector to select. The use of colored selectors that have a high contrast with the color of the housing makes it easier for a user to quickly make a selection when a trip needs to be classified. For example if a visual and/or sound notification reminds the user, once a trip has begun, that the trip needs to be classified, the user can quickly press the button with the appropriate color (for example blue for personal or green for business) without having to look at the device for very long. This allows the user to spend very little time looking at the device while classifying a trip, and thus decreases distraction, decreases the time a user's eyes are not on the road, and decreases the likelihood of a vehicle accident, vehicle damage, injury and death. The examples of using grey/black, bright blue, and bright green are only examples, and any other colors could be used for the housing and/or for the selectors.

The selectors could additionally or alternatively have letters on them, as shown in FIG. 1A (“P” on the personal selector and “B” on the business selector, for example). The letters may have a high contrast relative to the background color of the selector. In implementations the letters could be omitted. If high contrast letters are used, they may provide the same benefits as are discussed above for colored selectors.

In implementations in which there is only one indicator light and the indicator light is used to remind the user to classify a trip as business or personal, the indicator light is a “classification reminder indicator light.” In implementations in which there is only one indicator light and the indicator light is used to provide a visual notification to the driver when audio is being recorded, or is about to be recorded, or is about to stop being recorded, or has stopped being recorded, the indicator light is a “recording indicator light.” In implementations in which there is only one indicator light and the indicator light provides both the classification reminder function and a recording notification function, the single indicator light may be both a “classification reminder indicator light” and a “recording indicator light.”

Once the audio file has been communicated to device 122, device 122 may have the audio file transcribed, such as using the app itself or using a third party transcription service accessed via another app and/or through the network 120. For example the audio file may be uploaded to a remote server, the transcription may be performed using the remote server, and then the transcription may be downloaded back to device 122 and/or to a data store. If the transcription is provided from a remote server to device 122 or of the transcription is executed by device 122 itself, device 122 may upload the transcription to a remote data store. Whether the transcription is stored in a remote data store or not, a copy of the transcription may be stored locally in memory of device 122.

In implementations the software app installed on device 122 may be configured to have native transcription ability, so that the transcription is done locally through software and a processor of device 122 without uploading the audio file to a remote server. In other implementations software installed on device 126 may be configured to have native transcription ability so that the transcription is done locally through software and a processor of device 126, and the transcription communicated to device 122 instead of the audio file. In some implementations the original audio file may remain stored locally on device 122 permanently (or for a predetermined amount of time) and/or may be uploaded from device 122 to a data store 108 for later listening by the user, so that for example if when later reviewing the transcription the user believes it may be incorrect, the user may listen to the audio file and edit the transcription accordingly.

In implementations, when the user reaches the intended destination, device 122 may determine, due to sensing the vehicle stopping through GPS and/or accelerometer sensors, that the trip has ended. Device 122 may at that time store, locally and/or in the data store, an end date and time for the trip, a distance (such as number of kilometers or miles from the start location to the end location), and an end location (such as GPS coordinates or an address), which a user may later view on one or more user interfaces shown on device 122, and/or a website, to review the trip details. A map interface may be included when displaying the trip details to the user.

In some implementations the system may be configured to query the user, and/or the user may be able to select during or after a first trip, that a round trip is expected, so that details of the next trip will be stored locally on device 122 and/or the data store but also associated with the first trip as a return trip so that the user will not need to be prompted to record a description of the return trip or classify it as personal or business again. In some implementations the system may be configured to automatically determine that a return trip has occurred (such as by determining that the end location of the second trip is the start location of the first trip) and may automatically store the two trips in the data store or locally on device 122 as one round trip.

In some implementations the system may allow the user to pause a business or personal trip, such as by pressing the opposite button than that previously selected, to deviate from business to personal or vice versa (such as deviating from a personal trip to mail a business item), and then press the other button thereafter to resume the business or personal trip that had previously been begun, so that mileage will be accurately recorded for the business portions of the trip.

In implementations selectors 132/134 could be touch selectors, touchscreen selectors, push buttons, and so forth. In the implementations shown in the drawings they are push buttons.

Reference is now made to FIG. 1B which shows a block diagram representatively illustrating elements of device 126. The housing 128 of device 126 is representatively illustrated, as are the business selector 132, personal selector 134, and indicator light 136. An audio input/output 139 is representatively illustrated, which includes the aforementioned speaker 138 and which also includes a microphone. A processor 140 is seen communicatively coupled with the selectors, the indicator light, and the audio input/output. A wireless communication module 142 is seen communicatively coupled with the processor and electrically coupled with a power module 144. The power module is also electrically coupled with the processor, the indicator light, and the audio input/output. A memory 146 is electrically coupled with the power module and is communicatively coupled with the processor.

The configuration in FIG. 1B is only one example among many that could be given. Although the processor, memory, and wireless communication module are shown as discrete elements, they could be formed on a common chip, such as using a system on a chip (SoC) configuration. The power module could include a battery or it could include a connector that connects with an external power source, such as a cigarette lighter power source in the vehicle. In the implementation shown the power module may power the processor, indicator light, audio input/output, memory (if needed) and wireless communication module. The selectors could also be powered, if needed (for example in a situation where they are backlit or where the selection function is facilitated by powering them). The selectors are configured to provide signals to the processor, and software or logic stored in memory may be accessed by the processor to control the indicator light, speaker (using audio files stored in memory), microphone, and wireless communication module. The processor could also control the power module, such as placing the device in a low power mode or off mode after a predetermined amount of time of non-use. Audio input from the audio input/output may be received by the processor and stored in memory and/or communicated to a mobile phone using the wireless communication module. As discussed previously, the wireless communication module may be a BLUETOOTH module, an NFC module, or may implement any other communication protocol. FIG. 1B is a simplified diagram, as other elements may be present (such as diodes, capacitors, a printed circuit board interconnecting the various elements, and so forth). Additionally, there may be more than one of some elements—for example the processor may have a dedicated memory which includes stored logic for functionality of the device 126 and for stored audio files for playing via the speaker, while a separate memory may be used to store audio recordings of business purposes. Other configurations and variations are possible, and FIG. 1B is only a simplified representative example of one version—the practitioner of ordinary skill in the art will know how to deviate from the simplified version shown in FIG. 1B to arrive at a device that is useful for a given circumstance.

Reference will now be made to several drawings which depict representative examples of user interfaces that may be displayed on display 124 of device 122 to assist in implementation of the trip classifying methods. These may be user interfaces displayed using a software application installed on device 122. Similar or identical user interfaces may be available using a browser of device 122 or using a browser of a different computing device (for example a desktop computer, laptop, tablet, or the like may be used to view some of the user interfaces or variants thereof).

User interface screens additional to those shown in the drawings may be implemented in versions of the trip classifying systems/methods. For example, a first welcome screen may be shown to the user after installing and opening the software application. In this example the app is called TAXBOT and a welcome message on this first welcome screen may display a cartoon robot along with the wording: “Hi, I'm Taxbot, your friendly tax-saving robot!” A second welcome screen which follows the first may display the text: “I take the work out of tracking your mileage and expenses.” A third welcome screen which follows the second may discuss automatic mileage tracking. On this screen the following text may be displayed: “Sometimes humans forget to track a business trip. That's why I track your trips automatically using your phone's GPS.” A fourth welcome screen which follows the third may display the text: “I can even fill in the purpose of your trip with entries from your online calendar.” A fifth welcome screen may discuss receipt matching and may state: “When you take a photo of your business receipt, I'll match it with your bank and credit card expenses automatically.” A sixth welcome screen may display the message: “Then I can fill in information that the IRS looks for in an audit, keeping everything safely in one place.” Welcome screens having these details are included in the drawings of the parent provisional application which has been incorporated herein by reference.

FIG. 2 shows an interface 200 that includes a log in selector and a selector to start a free trial. The user in this example selects the free trial selector and is brought to interface 300 of FIG. 3 which has fields to input an email and a chosen password. There is also a login selector on this interface in case the user realizes he/she already has an account and can log in. After the user inputs the email address and password a “Next” selector appears which, when selected, brings the user to interface 400 of FIG. 4.

On interface 400 are fields for the user to input a first and last name and a phone number. There is also a login selector on this page in case the user realizes he/she already has an account and can log in. After the user inputs the first and last name and phone number a “Next” selector appears which, when selected, brings the user to an interface 500 shown in FIG. 5. Interface 500 gives the user details regarding “SMARTMATCH” email settings and includes a DONE selector to close the interface and bring the user to a home interface 600 of FIG. 6. Alternatively, the user can select the GO TO SMARTMATCH SETTINGS selector and will be brought to interface 3200 of FIG. 32, which will be discussed in more detail later. In this example the user selects the DONE selector and is brought to the home interface 600 of FIG. 6.

FIG. 6 shows, along the top, a refresh selector, a chat selector, and a settings selector. A total dollar amount of deductions is displayed. An expenses section includes an indication of a number of expenses to be classified and a selector to submit a receipt. A mileage section includes an indication of a number of trips to be classified and includes a selector to submit a new trip. The mileage section also includes a selector to toggle auto-tracking on and off—in FIG. 6 it is toggled off and the message “AUTO-TRACK DISABLED” is displayed. If it is toggled on and there are no auto-tracked trips for that day the message may state “AUTO TRACK NOT USED TODAY.” On days on which auto-track is turned on and has been used to track at least one trip it may say “11 miles auto-tracked today” or “3 trips auto-tracked today” or the like. Interface 600 also includes an income section displaying an indicator of a number of income items to be classified and a selector to submit a new income item. A message is displayed below the income section which states: “PLEASE UPDATE THE YEAR START ODOMETER.” This message will be removed on the home interface once the user has updated the starting odometer reading for the present year for the default vehicle. Along the bottom of the home interface are selectors displayed throughout the app (i.e., not just on the home interface, but on other interfaces), including a Home selector to bring a user back to the interface 600 of FIG. 6, a Trips selector, an Expenses selector, an Income selector, and a More selector. One of these is highlighted or shown in a different manner to show the user which interface is being displayed; in FIG. 6 the HOME selector is highlighted or shown differently to show that the user is currently viewing the home interface 600.

In this example the user selects the chat selector at the top of FIG. 6 and is brought to interface 700 of FIG. 7. In implementations when this interface is first shown, a window appears to request overlay access. This may say, for example: “ALLOW OVERLAY—IN ORDER TO USE THE LIVE CHAT FEATURE YOU MUST ALLOW TAXBOT TO BE ABLE TO DISPLAY OVER OTHER APPS.” Other text could be used. This window may include a CANCEL selector and an ALLOW selector. If the user selects CANCEL then the chat interface closes and the user is brought back to the home interface. If the user selects the ALLOW selector then the chat functionality is enabled. The user in this example selects the ALLOW selector and then the interface 700 appears as it is presented in FIG. 7. The user may input any characters in the message field using the provided keyboard interface and/or may attach any file using the attach selector (paperclip image) to send a message or file to an administrator or help/support person.

From interface 700, the user in this example selects the BACK selector (left-facing arrow) or the cancel selector at the top right to return to the Home menu. The user then selects the settings selector (gear icon) at the top right and is brought to interface 800 of FIG. 8.

Although not shown, the interface of FIG. 8 may include a back selector similar to interface 700 to return to the home interface. It may also include an indicator of a software version and a help/support phone number. A selector for USA or Canada is shown for users to indicate their location. A VEHICLES section includes a MANAGE VEHICLES selector and a MANAGE ODOMETERS selector. A BUSINESS section includes a MANAGE BUSINESSES selector. A BANKS section includes a MANAGE BANKS selector. A CATEGORIES section includes a MANAGE EXPENSE CATEGORIES selector and a MANAGE INCOME CATEGORIES selector. A TRIPS section includes a TRACKING SETTINGS selector. A TAXBOT VOICE section includes a MANAGE TAXBOT VOICE selector. A SMARTMATCH section includes a SYNC EMAIL selector. An ACCOUNT section includes a SUBSCRIPTION DETAILS selector, a CHANGE PASSWORD selector, and a LOG OUT selector. Each of these will be explained in detail further below.

In implementations interface 800 or another interface may have a location to link accounts. For example one or more fields may be included for a user to input one or more emails of accounts to link to. This could link persons/accounts within a common business organization, all of whose expenses may be included on the tax return of the business. For example if a business includes ten persons, each of whom incurs expenses that should be included on the tax return of the business, all ten accounts may be linked together in the app so that all expenses/trips and the like are compiled into master lists instead of only having ten separate expense lists and the like.

Referring still to FIG. 8, if the user selects the MANAGE VEHICLES selector the user is brought to interface 1400 of FIG. 14. This interface lists all vehicles that have been input. The top shown vehicle is the default vehicle, listed under the DEFAULT header. Below this is the ALL header which lists all other vehicles associated with this user. Each user may include multiple vehicles and may select one as his/her default vehicle. If the user selects the SET AS DEFAULT selector next to any of the non-default vehicles, that vehicle will be then listed as the default vehicle and the prior default vehicle will return to the list under the ALL header. If the user taps on any of the listed vehicles an EDIT VEHICLE interface will appear which lists the name of the vehicle and allows the user to change the name. A CANCEL selector and a BACK selector on this interface allow the user to return to the prior screen (interface 1400). A SAVE selector allows the user to save the changes to the vehicle name. A DELETE selector (trash can icon) allows the user to delete the vehicle. If the user selects the DELETE selector a confirmation window appears which asks: “Are you sure you want to do this?” and includes CANCEL and BACK selectors, each of which cancels the action and returns to the prior interface, and an OK selector which goes forward with deletion of the vehicle.

On FIG. 14, if the user selects the plus icon, an ADD VEHICLE interface/window appears which includes a field to enter a name for the new vehicle, BACK and CANCEL selectors which, if selected, close the window and return the user to interface 1400, and a SAVE selector which saves the new vehicle.

Returning to FIG. 8, if the user selects the MANAGE ODOMETERS selector the user is brought to interface 1600 of FIG. 16. This is an odometers interface and shows all vehicles for which odometer readings have been input, listed by year. For example, in FIG. 16 the 2015 TOYOTA COROLLA (which is shown to be the default vehicle) is seen to have an odometer reading input for the year 2020. This is the beginning-of-year odometer reading for the vehicle. If the user clicks on the 2020 text an EDIT VEHICLE interface is brought up which allows the user to edit the beginning-of-year odometer reading for the vehicle. The user can also edit the year of the odometer reading and can even edit the vehicle (from a dropdown of selectable vehicles that were previously input as described above). BACK and CANCEL selectors may be selected to return the user to interface 800. A DELETE selector (trash can icon) can be used to delete the odometer reading, which if selected will bring up a confirmation window as described above for other delete selectors. A SAVE selector will save the edits. On the interface of FIG. 16 if the user selects the plus icon the user is brought to interface 1500 of FIG. 15 to add a new vehicle, which includes selecting the vehicle (from a dropdown of previously input vehicles), entering a year, and entering an odometer reading for the beginning of the year. BACK and CANCEL selectors return the user to the prior screen and a SAVE selector saves the new vehicle.

Returning back to FIG. 8, if the user selects the MANAGE BUSINESSES selector the user is brought to a BUSINESSES interface whereon the user may see businesses already added and may add additional businesses. This interface has a BACK selector to return to interface 800 and a plus icon to add a new business. If a user selects the plus icon the user is brought to an interface whereon the user may add a new entity. A name field allows the user to add a name for the business using a keyboard interface. The user may select a CANCEL selector to cancel adding the new entity or a SAVE selector to save the new entity. Once the new entity is added, from the BUSINESSES interface the user may select the business to bring up interface 1700 of FIG. 17 where the user can edit the entity name, delete the entity (after a confirmation warning), save the edited changes, or cancel the changes.

Returning back to FIG. 8, if a user selects the MANAGE BANKS selector the user is brought to a BANKING interface whereon the user may see a list of bank accounts that are linked to the software app. This may be useful for automatic importing of bank transactions into the app. Once a bank account has been entered, on the BANKING interface the user may select a bank account to edit its details. The BANKING interface has a BACK selector to return to the prior screen and a plus icon to add a new bank account. When the user selects the plus icon, interface 1800 of FIG. 18 is brought up. The user may select any of the top-listed most popular banks (which list may include bank icons, bank names, and website addresses) or may enter text into the search field and search for a banking institution. Once the user selects a banking institution the user is brought to interface 1900 of FIG. 19. In this example the user has selected CHASE BANK. Interface 1900 may include the bank icon, bank name, bank website address, a BACK selector which returns the user to interface 1800, and a NEXT selector which takes the user to a login page to enter login credentials for the bank. Text on interface 1900 tells the user that the user will be signing in through the CHASE BANK website and that the app administrators/operators will not see the user's login credentials. lithe user selects the NEXT selector, interface 2000 of FIG. 20 is shown. This is similar to FIG. 19 and instructs the user to select a CONTINUE selector to open a secure sign-in window and connect the user's bank account to the app. The user can alternatively select a CANCEL selector to return to interface 1800. If the user selects the continue button, a browser opens a login website for the banking institution which allows the user to link the bank account with the software app. The linking of bank accounts with the app may allow the system to auto-match receipts with bank records.

Returning to FIG. 8, if a user selects the MANAGE EXPENSE CATEGORIES selector the user is brought to interface 2100 of FIG. 21. This is a list of expense categories that the user may later use to categorize expenses through the app. A BACK selector allows the user to return to interface 800, and a plus icon brings up an interface allowing the user to add a new expense category, which allows the user to add a name for the new category and select between “MEALS AND ENTERTAINMENT,” “GENERAL,” and “AUTOMOBILE.” This interface includes selectors to SAVE the new category or CANCEL the new category. From interface 2100, if the user selects any of the existing expense categories the user is brought to interface 2200 of FIG. 22 which includes an EDIT CATEGORY window allowing the user to edit the expense category. The user can edit the name, toggle between “MEALS AND ENTERTAINMENT,” “GENERAL,” and “AUTOMOBILE,” and select selectors to SAVE the edits, CANCEL the edits, or DELETE the category (after a confirmation window). Text on interface 2200 instructs the user as to the selection of the “MEALS AND ENTERTAINMENT,” “GENERAL,” and “AUTOMOBILE” options.

Returning to FIG. 8, if a user selects the MANAGE INCOME CATEGORIES selector the user is brought to interface 2300 of FIG. 23. This is a list of income categories that the user may later use to categorize income through the app. In FIG. 23 there is only one generic listed item, titled “INCOME,” but other income categories could be included, such as “profit from product sales,” “savings account interest,” and so forth. A BACK selector allows the user to return to interface 800, and a plus icon brings up interface 2500 of FIG. 25 allowing the user to add a new income category, which allows the user to add a name for the new category and includes selectors to SAVE the new category or CANCEL the new category. From interface 2100, if the user selects any of the existing income categories the user is brought to interface 2400 of FIG. 24 which includes an EDIT CATEGORY window allowing the user to edit the income category. The user can edit the name and may select selectors to SAVE the edits, CANCEL the edits, or DELETE the category (after a confirmation window).

Returning to FIG. 8, if the user selects the TRACKING SETTINGS selector the user is brought to interface 2600 of FIG. 16 whereon the user may toggle the AUTO-TRIP TRACKING on or off. In FIG. 26 it is toggled off. On interface 2700 of FIG. 27 (which is the same interface as interface 2600 but with the AUTO-TRIP TRACKING toggled on) a new SCHEDULED TRACKING selector appears, which in FIG. 27 is toggled off. If the user turns on auto-tracking and the mobile device's GPS sensor/module is not turned on, a message may appear which states “NO LOCATION AVAILABLE—TAXBOT needs to access your location to track your trips. Press OK to go to the settings.” A CANCEL selector and an OK selector may be shown on this interface. If the user selects OK the user is brought to the mobile device's GPS settings to turn on GPS sensing. Another message may appear after this which says “KEEP IN BACKGROUND—In order for TAXBOT to automatically track your trips, please allow us to run in the background” and may include an OK selector to allow the app to run in the background and a CANCEL selector to disallow the app from running in the background.

On interface 2800 of FIG. 28 (which is the same interface as interface 2700 but with the SCHEDULED TRACKING selector toggled on) a list of days and times appears. The user may select specific days (with checkmark boxes), and edit the specific times (by clicking on any of the times), during which automatic trip tracking will be done. For example, the user may decide to turn on automatic trip tracking Monday-Friday from 9 AM to 5 PM, and off at other times. In the example of FIG. 28 the user has selected for the automatic trip tracking to be turned on Tuesdays and Thursdays from 7 AM to 8 PM. If the user selects one of the times (for example the start time for Thursday) an interface such as interface 2900 of FIG. 29 appears which allows a user to edit the time. If the user clicks the hour portion on the time above the user may then manually tap a location on the clock below to select a different hour. When the user clicks on the hour portion above, the clock below may simply show one hand and numbers 1 through 12 located around the clock. If the user clicks on the minutes portion above, the user may then manually tap a location on the clock below to select a different minute. When the user clicks on the minutes portion above, the clock below may simply show one hand and numbers in increments of 5 from 0 to 55. The user may hold the clock hand and drag it to get to any desired minute. The user may toggle between AM and PM as well. A CANCEL selector cancels the new time and a SAVE selector saves the new time. In FIG. 29 the user has edited the Thursday start time to 10:11 AM. Once the user has edited the time and selected SAVE, the new time will be reflected in interface 3000 of FIG. 30 (which is the same interface as interface 2800 but with the time edited). In FIG. 30 the user has changed the Thursday start time to 10:00 AM.

The auto-tracking and scheduled auto-tracking options may effectively turn on/off the trip classifying methods which use a trip classifying device.

Returning to FIG. 8, if a user selects the MANAGE TAXBOT VOICE selector the user is brought to interface 3100 of FIG. 31, which provides instructions to the user on how to set up and use the trip classifying device (which is called the TAXBOT VOICE DEVICE in interface 3100). The user is instructed to charge the trip classifying device and turn it on, then search on the phone's BLUETOOTH settings for the device by name to pair the trip classifying device with the phone. Once this connection is made, the user may leave the trip classifying device on and attach it to the vehicle visor. This process may be repeated for as many trip classifying devices as the user has (e.g., multiple devices for multiple vehicles which will be used for business trips). The user is also given simple instructions on FIG. 31 of how to use the trip classification once a trip begins. Other methods may be included/used to pair the devices. For example the trip classifying device may not have a power switch, but may automatically transmit a BLUETOOTH signal when it has a charged battery, though having a power switch is useful to turn off the device if it is known that it will not be used for a long period of time (for instance during a vacation). The trip classifying device may have a button or selector configured to begin the pairing process, for instance a button may be included which, when pressed, then sends out a BLUETOOTH SIGNAL which the phone may then detect and use to pair the phone with the trip classifying device. FIG. 31 may have a selector which automatically begins the process (or completes the process) of pairing the phone with the trip classifying device or which navigates the user to the BLUETOOTH settings of the phone to begin the process. Interface 3100 is also seen to list the entered vehicles and to have an option of associating specific vehicles with specific trip classifying devices, so that mileage for any given trip is associated with the appropriate vehicle automatically. The user has a dropdown to select the specific trip classifying device for each vehicle—the dropdown options may change automatically depending on which trip classifying devices are linked with the mobile device. This section could alternatively list the linked trip classifying devices and have a dropdown to select the appropriate vehicle from a list of entered vehicles. Other options are possible with interface 3100, and the practitioner of ordinary skill in the art will know how to adjust interface 3100 and the pairing methods/steps according to any specific implementation.

Returning to FIG. 8, if the user selects the SYNC EMAIL selector the user is brought to interface 3200 of FIG. 32. From this interface the user can input an email that will be used for receipt forwarding. For example, if the user receives digital business receipts at a GMAIL email account, the user will input that email address here and select SUBMIT. After this is done, an email will be sent to the email address with instructions on how to continue setting up email forwarding. This basically involves setting up an automatic forwarding rule with the email provider so that all emails received at the email address are forwarded to a second email address (in this example “incomingreceipts@taxbot.com”) so that the system 100 has access to all of the business receipts/emails and may store them in the data store. The system may then use these to facilitate automatic matching between receipts and bank transactions.

Returning to FIG. 8, if the user selects the SUBSCRIPTION DETAILS selector the user is brought to interface 3300 of FIG. 33 which includes details about subscribing to the services provided through the system 100 after a trial period ends. This interface also includes a phone number, email address, and FACEBOOK messenger details to communicate with customer support. Links are also provided to a privacy policy and terms of use.

Returning to FIG. 8, if the user selects the CHANGE PASSWORD selector the user is brought to interface 3400 of FIG. 34 where the user may input the current password and insert a new password (and repeat the new password), then select the RESET PASSWORD selector to reset the password. The user may alternatively select the native BACK button of the mobile device to return to the prior interface.

Returning to FIG. 8, if the user selects the LOG OUT selector the user may be brought to interface 3500 of FIG. 35 (which is interface 800 with an overlaid confirmation window) which includes BACK and CANCEL selectors both of which return to the prior screen leaving the user logged in and an OK selector which logs the user out.

Returning to FIG. 6, if the user selects the SUBMIT TRIP selector the user will be brought to interface 3600 of FIG. 36. This interface includes a notification that location services are disabled (if GPS is turned off), a selector to add mileage manually, and a selector to calculate mileage using locations on a map. If the user selects the notification that location services are disabled the user is directed to turn on GPS on the mobile device (or the app may automatically bring up the mobile device's GPS settings for the user to turn GPS on). When the user then returns, or thereafter selects the SUBMIT TRIP selector from interface 600, interface 3700 includes a START MILEAGE TRACKING selector at the top. Interface 3700 is the same interface as interface 3600 but with the START MILEAGE TRACKING selector replacing the notification that location services are disabled.

Still referring to interface 3700, if auto-tracking is turned on and the user selects the START MILEAGE TRACKING selector, the user will be instructed to turn off auto-tracking (if the user wants to manually do mileage tracking). If the user turns off auto-tracking and then selects the START MILEAGE TRACKING selector the user is presented with an interface which includes a selector to start a new trip (or add a leg or lap to the trip) and a selector to end trip tracking. When the user manually starts the mileage tracking the user will be presented with an option to classify the trip as a personal or business trip and to provide a business purpose if it is a business trip.

Still referring to interface 3700, if the user selects ADD MANUAL MILEAGE the user is brought to interface 3800 of FIG. 38 where the user may enter a date, day, and time, select the vehicle (from a dropdown of all vehicles input), may select the business (from a dropdown of all businesses input), manually enter the start location and the end location (which will automatically calculate the mileage, though the user may be able to manually input/edit the mileage), toggle between PERSONAL or BUSINESS (in FIG. 38 it is toggled to BUSINESS as the default because the PERSONAL toggle is off), indicate whether the trip is a round trip (in FIG. 38 it is toggled to one-way as the default because the ROUND TRIP toggle is off), provide a business purpose, and select SAVE to save the trip, or CANCEL to cancel the trip. In FIG. 38 the user has selected the 2015 TOYOTA COROLLA as the vehicle and BOB'S ACCOUNTING LLC as the business associated with the trip. The PERSONAL and ROUND TRIP toggles may change color, for example changing from black or grey to a bright color, such as bright orange, when toggled on, so the user may quickly tell that they are toggled on. If the user presses SAVE then the user may be brought to interface 4000, which may show the saved and classified trip, and the wording “TRIP SAVED SUCCESSFULLY” may temporarily appear on this screen to notify the user that the trip has been saved.

Interface 3900 of FIG. 39 shows the trip once it has been fully input. The start and end locations have been entered, the date and time were entered, the personal toggle is left off (toggled to the left) to indicate that the trip is a business trip, and the round trip selector was toggled on. The distance between the start and end locations is 7.5 miles, and this is calculated automatically, but when the user toggles the round trip selector on the distance is calculated as double this, 15 miles, to include the return trip. The business purpose has been entered as “BUSINESS DEV LUNCH” meaning business development lunch. In implementations the PERSONAL and ROUND TRIP toggles may change the wording when the toggle is selected—for instance the PERSONAL toggle may change the wording from PERSONAL to BUSINESS and back and the ROUND TRIP toggle may change the wording from ONE WAY to ROUND TRIP and back so that the wording reflects the current selection. In the implementation shown in the drawings, however, the wording stays PERSONAL and ROUND TRIP and the toggle simply indicates a yes or no—toggled to the left for NOT a personal trip or NOT a round trip, and toggled to the right for YES a personal trip or YES a round trip.

Returning to FIG. 37, if the user selects CALCULATE MILEAGE the user is brought to interface 4400 of FIG. 44 which allows the user to add a start location and end location (each with either a typed address, a current location as determined by GPS, or by dropping a pin on a location on the map). In this example the user manually entered an address for the start location, using the keyboard interface. On interface 4500 of FIG. 45 (which is the same interface as interface 4400 but with the start location already input) the user has selected DROP A PIN for the end location, which brings up a map and allows the user to drop a pin, which automatically inserts an address (or, in some locations, GPS coordinates) into the END location. When the user selects DONE, interface 4600 of FIG. 46 is displayed, which shows the date and time of the trip (which may be edited), a map, the distance of the trip in miles (which may be edited), the start and end locations (which may be edited), the vehicle and business associated with the trip (in this case the default vehicle and default business are input automatically but may be edited), a toggle to select Personal or Business (here this is toggled to BUSINESS because it is set to the left to indicate it is NOT a personal trip), a toggle between Round Trip and One-Way (here this is toggled to Round Trip), a purpose of the trip which the user may edit (here the user has input “CLIENT DINNER TO DISCUSS CONTRACT”), a CANCEL selector to cancel the trip and a SAVE selector to save the trip.

Returning to the home interface 600 of FIG. 6, if the user selects the CLASSIFY TRIP selector the user is brought to interface 900 of FIG. 9. The user may toggle between Unclassified and Classified trips by selecting UNCLASSIFIED or CLASSIFIED at the top. A horizontal bar below these shows which is selected—in this case the UNCLASSIFIED trips are shown. There is one unclassified trip to classify, a trip on Friday of 18 miles. The user may swipe the trip to the left to classify it as a PERSONAL trip or may swipe the trip to the right to classify it as a BUSINESS trip. In instances where there are no trips to classify this interface may state “You do not have any trips to classify. Enable auto-trip tracking to automatically record the trips you take.” If the user had a trip classifying device in his/her vehicle but did not select B or P during any given trip, for example, the trip may show up here in as an UNCLASSIFIED TRIP, and the user may then manually classify it as a personal trip or business trip by swiping it to the left or right. Interface 900 states UNCLASSIFIED TRIPS at the very top of the interface, but if the user toggles to CLASSIFIED then the top language will state CLASSIFIED TRIPS or simply TRIPS. Interface 900 includes an ENABLE AUTO-TRIP TRACKING selector which, if selected, will bring the user to interface 2600, previously described. Interface 900 includes a plus selector at the top right which, if selected, will bring the user to interface 3600 or 3700 (depending on whether GPS or another location service is turned on), previously described. Interface 900 also includes an ADD A NEW MANUAL MILEAGE TRIP selector for adding a new manual mileage trip. If the user selects this the user is brought to interface 3800, described above, for manually adding a trip. Interface 900 also includes a START TRACKING A NEW MANUAL TRIP selector. If the user selects this the user is brought to interface 3600 or 3700 (depending on whether GPS or another location service is turned on), described previously. If the user has turned on auto-tracking and is using the trip classifying device 126 then, naturally, the ADD A NEW MANUAL MILEAGE TRIP and START TRACKING A NEW MANUAL TRIP selectors may not need to be used.

Returning to FIG. 6, if the user selects the SUBMIT RECEIPT selector (plus sign above the wording) a popup appears which states “PERMISSION—TAXBOT needs to access your external storage for receipts. This ensures that all of your receipts will stay on your device even if the app must be reinstalled. An OK selector is included which, when the user selects it, brings up another window from the mobile device's operating system which states “Allow TAXBOT to access photos, media, and files on your device” and includes a DENY selector and an ALLOW selector. The user may deny the request if desired. If the user wishes to save receipt images, the user can select the ALLOW selector and the user will then be brought to a camera interface which allows the user to snap photos of receipts.

With regards to the permission windows and notifications discussed herein, such as the one discussed in the above paragraph for giving the app permission to access photos, media, and files, it is to be understood that the permission warnings, notifications and windows/popups only appear until the user has granted permission. Once permission has been granted or the required task has been completed for a specific window or area of the app, the notification no longer appears thereafter. For example, once the user has granted permission to access photos media and files, thereafter when the user selects the SUBMIT RECEIPT selector on interface 600, the user is simply brought to a camera interface which allows the user to snap a photo of a receipt. The app may work in conjunction with the native camera app of the mobile device in order to take photos of receipts and save them, so that when the user selects SUBMIT RECEIPT it is the native camera app that is opened, but with the TAXBOT app saving a copy of the snapped photo in the data store and/or locally on the phone associated with the user through the TAXBOT app.

Returning to FIG. 6, if the user selects the plus icon above SUBMIT INCOME the user is brought to interface 4700 of FIG. 47. The user here can select or input the date, time, income category, business, total amount, client (which may be selected from a pre populated list of clients input on another interface not shown in the drawings), a description, and the user may then select CANCEL to cancel the added income or may select SAVE to save the added income. In this example the user has used the generic “INCOME” income category and has selected the business as BOB'S ACCOUNTING LLC. In implementations some fields may have a default entry, for example the date and time may default to the current date and time, the generic “INCOME” category may be the default income category, and the default business may automatically be input in the business field (though any of these can be edited).

Returning to FIG. 6, if the user selects the CLASSIFY TRIP selector (i.e., the circle showing the number of trips to classify, above the wording “CLASSIFY TRIP”), the user is brought to interface 900, previously discussed. The user can toggle between the UNCLASSIFIED trips and the CLASSIFIED trips. In FIG. 9 there is one unclassified trip that the user can classify by swiping to the left (for personal) or to the right (for business). If the user toggles to the CLASSIFIED trips list, interface 4000 of FIG. 40 is shown (which is the same interface as interface 900 except toggled to the CLASSIFIED trips list). The CLASSIFIED trips list shows three trips in October 2020, one on October 5 and two on October 12. Two of these are business trips, one for 7 miles and another for 15 miles, and the total business miles is shown at the top. One of the trips is a personal trip, for 23 miles, and its mileage is not included at the top.

It is seen on FIG. 40 that each of the business trips includes a description. The October 5 business trip includes the description “MET WITH SARAH JONES TO DISCUSS CONTRACT” and the October 12 business trip includes the description “BUSINESS DEVELOPMENT LUNCH WITH JOHN SANDERS.” These may be input manually, through the app, but they may also have been input automatically using the trip classifying device. For example, as the user is beginning a trip, the trip classifying device may have provided a chime or beep and/or a light to remind the user to select the business selector or the personal selector. For the October 5 trip the user selected the business selector and then the recording automatically began, and the user stated: “Met with Sarah Jones to discuss contract.” The trip classifying device recorded the statement, communicated it to the mobile phone where transcription was initiated (either transcription by software on the phone or using a remote server), and the classification as a business trip along with the transcription “MET WITH SARAH JONES TO DISCUSS CONTRACT,” was saved in the data store. The date of the trip and the final mileage were also stored in the data store and/or locally on the mobile device, once the trip was complete and the system could determine the final mileage using the phone's GPS positions. When the user later navigates on the mobile app to the classified trips list, the classification and transcription appear on the user interface. A similar process was followed for the October 12 business trip, except in that case the user spoke the phrase: “Business development lunch with John Sanders.” The second October 12 trip was a personal trip. In this case when the user was reminded to classify the trip the user selected the personal selector. This classified the trip as a personal trip. The user later manually entered, through the app, the purpose of picking up an uncle from the airport. The system automatically determines the mileage. In implementations the system 100 could be modified so that a recording automatically starts for a personal trip, and the user can record a purpose and have it automatically transcribed for the personal trip. In the implementations shown in the drawings, however, the system only automatically records audio for business trips. This is useful so that the user is no more distracted than is necessary during a trip. The user can tap on any listed trip to be brought back to a screen similar to interface 3900 of FIG. 39 to edit or delete a trip.

Returning to FIG. 6, if the user selects the Classify Expense selector (i.e., the circle showing the number of unclassified expenses, above the “CLASSIFY EXPENSE” wording), the user is brought to interface 1100 of FIG. 11. The user can toggle between unclassified and classified expenses. The user is currently viewing unclassified expenses and there is only one to view, a Jul. 12, 2019 expense at an OFFICE MAX store. The listing shows the card used (last four digits and issuing bank), the vendor, the location, the date, and the amount. The user can swipe to the left to classify it as a personal expense or swipe it to the right to classify it as a business expense. This interface includes a selector to upload a new receipt, a selector to link a new bank account, a selector to link a new email address, and a selector to view queued receipts. If the user selects the UPLOAD A NEW RECEIPT selector the camera interface is brought up for snapping a photo of a receipt, described previously. From the camera interface the user can, instead of snapping a new photo, navigate to a stored photo already on the phone (or accessible by the phone). If the user selects the LINK A NEW BANK ACCOUNT selector the user may be brought to interface 1800, described previously. If the user selects the LINK A NEW EMAIL ADDRESS selector the user may be brought to interface 4100 of FIG. 41. The user here may select CANCEL to revert to the previous screen, may select the LINKING OTHERS selector to be brought to a tutorial or description about linking emails other than GMAIL accounts, or may select the LINK GMAIL Selector to be brought to a tutorial or explanation about linking a GMAIL email account. The LINK GMAIL selector may, alternatively, navigate the user to interface 3200, previously described. Receipt images can also show up in the unclassified or classified list. For example, interface 1000 of FIG. 10 shows a receipt image 1002 that has been matched to a credit card transaction, but it is not yet classified as a personal or business expense. The user can here swipe the receipt to the left or to the right to classify it. Email receipts also show up in the unclassified list, after they are matched to an existing bank account or credit card transaction, so that the user can classify them as personal or business expenses. For example, the unclassified expense shown in FIG. 11 could be from an email receipt. If there are no unclassified expenses yet, interface 1100 may initially state “You do not have any Smart Matches to classify. It may take a few days for your receipts to be matched with transactions from your bank.”

In implementations the system may only accept one linked email account, and only a GMAIL account. However, the user may be able to forward another email account type (which receives business receipt emails) to a GMAIL account and then forward those GMAIL emails for smart matching. Additionally, the user may be able to forward multiple email accounts (all of which receive business receipt emails) to one GMAIL account, and then forward emails from that GMAIL account for smart matching.

If the user selects the clock icon in the top left of interface 1000 or interface 1100 (or the VIEW QUEUED RECEIPTS selector on interface 1100), the user is brought to interface 4200 of FIG. 42 and shown a queue of receipts that have not yet been matched to banking or credit card transactions. There is nothing to do on this screen, it is just for the user to see receipts that have not yet been “smart matched.” Receipt images 1002 may be shown here, along with email receipt summaries (similar to the CITICARD receipt summary shown on FIG. 11). Once the receipts are matched to banking or credit card transactions, they will show up as unclassified expenses for the user to classify them.

Returning to interface 600 of FIG. 6, if the user selects the CLASSIFY INCOME selector (i.e., the circle showing the number of unclassified income items, above the “CLASSIFY INCOME” wording), the user is brought to interface 1200 of FIG. 12. Here the user may toggle between unclassified and classified income. The user is viewing unclassified income in FIG. 32 and there is one item to view, a $1,200 deposit/payment from Dan Smith (this could be a check, for instance). On this interface, as with the other Unclassified/Classified interfaces, in the Unclassified view the user may swipe a listed item to the left to classify it as Personal and may swipe it to the right to classify it as Business. The user can also select the plus icon to navigate to interface 4700 of FIG. 47, wherein the user may input income, described previously. If the user navigates/toggles to the CLASSIFIED list then interface 4300 of FIG. 43 is shown. This is the same interface as interface 1200, just toggled to the CLASSIFIED list. This list shows an Oct. 12, 2020 income item “Prepare Smith contract” listing income of $2,500. This may be income that was input manually or in some other way. The user may tap on the income item to navigate to an interface similar to interface 4700 to edit or delete the income item (or the user may decide to cancel the edit) (this interface would have a delete selector and, as with other interfaces, this interface may have functionality described elsewhere for other interfaces). Returning to FIG. 12, if the user uses the plus icon to manually add income, it may automatically (or by default) be classified as business income (though the classification may be edited). Income items from linked bank accounts and other financial accounts may appear in the unclassified list until they are classified by the user.

Returning to FIG. 6, if the user selects the MORE selector the user may be brought to interface 1300 of FIG. 13. This interface includes a chat selector and a call/text selector to reach customer support. A HELP section includes a CONTACT INFO selector which navigates a user to a contact page for calling or emailing or otherwise communicating with customer support. The HELP section includes a PRIVACY POLICY link. The HELP section includes a TUTORIALS selector which brings the user to a list of tutorial videos and explanations. The HELP section further includes a FEEDBACK selector which navigates the user to an interface for providing feedback to customer support. A USER section includes a PROFILE selector which navigates the user to an interface for editing a user profile. The USER section includes a SETTINGS selector which navigates the user to the interface 800 of FIG. 8. The REPORTS section includes a MANAGE REPORTS selector which allows the user to create, view and/or email reports related to trips/income/expenses, etc. The REWARDS section includes a TAXBOT REWARDS selector which navigates the user to an interface discussing a rewards program for referring other users.

Not all of the above-described user interfaces of the app are related specifically to trip classification, but those which are not related to trip classification have been included to add context. In general, the purpose of the app is to increase the ease with which a user may maintain records needed for reporting deductions, income, expenses, mileage, etc., for tax purposes.

When device 126 is used together with the app of device 122, the trip classification is made much easier. The user may still have entered certain information through the app, such as the vehicles and businesses associated with the user's account, and the user will have turned on automatic trip tracking. Additionally, on one or more user interfaces the user will have linked device 126 with device 122 through a BLUETOOTH or NFC or other communication link. The user may have also, on one or more user interfaces, associated a specific device 126 with a first vehicle, another device 126 with another vehicle, and so forth. The user interfaces may also include one or more selectors to specifically toggle on/off the use of device 126 with auto tracking (for example, some auto-tracking may be done using the phone alone, to track mileage, date, starting locations, end locations, etc., though without classifying between business/personal and without recording a business purpose during the trip).

To some extent, the interfaces already described indicate the frustration a user can have with regards to classifying trips. Software apps in the art can automatically track trip mileage, but they may not automatically classify between Personal or Business trips. The mileage of a personal trip is not tax-deductible, so it is important for the user to correctly classify all automatically-tracked trips as either Personal or Business. However, since users are often busy, the user may end up reviewing many trips after they have occurred (for example on the weekend after a full week of trips, or even later). This not only is time consuming for the user, it is also difficult for the user to remember whether any given trip was a business trip or a personal trip when the user is reviewing the list a day, a week, several weeks, or even several months after the trips have occurred. By the time the user gets around to classifying trips, the user may have many unclassified trips backed up, such as dozens or even hundreds. In order to try to determine which trips are Personal v. Business, the user may need to review a calendar and other items and may make inaccurate guesses.

The use of device 126 generally solves these issues. A user may place the device 126 on the visor of a vehicle using the coupler 130. Because the user has previously linked this device with device 122, when the user thereafter enters the vehicle, the proximity of the device 126 with device 122 automatically results in the two being linked through, in this example, a BLUETOOTH connection. When the user then starts driving, the software app of device 122 automatically starts tracking the trip, and the device 122 automatically notifies the user such as by illuminating or flashing the indicator light and/or providing a distinct chime/noise through the speaker. After hearing the distinct chime/noise or seeing the flashing/illuminated indicator light, the user can pre-classify the trip by selecting the personal selector or business selector for Personal or Business, respectively. Accordingly, the trip is classified while the user is still driving, mid-trip, so that the user does not need to later sit down and classify this trip as either Personal or Business.

After the user begins another trip the user may see the illuminated or flashing indicator light and/or hear the distinct chime/noise again, and in this case the user selects the business selector to classify this as a Business trip. A microphone of device 126 is then automatically activated so the user can dictate a business reason for the trip, to be recorded using device 126. In this case, for example, the user dictates “Met with John Richards to go over his contract.” Device 126 then communicates the recorded audio file to device 122 through the BLUETOOTH connection, so that the file may be transcribed either using device 122 or by a remote server or processor communicatively coupled with device 122, as previously described. The transcribed description is automatically saved and associated with the trip. For example, referring to FIG. 38, where the user manually selects Personal or Business and manually enters a purpose, in this case the selection between Personal or Business, and the description/purpose of the trip, as well as the vehicle, business, distance, date, and time, are all automatically recorded by the system, stored locally on device 122 and/or uploaded to the data store. The user may then later view the trip details through the app and/or through a web interface as previously described, may view total mileage of business trips when preparing taxes, and will have all necessary records to back up the mileage deduction in case of an audit.

System 100 may record GPS locations to record beginning and ending locations of trips and, with that information, determine mileage for each trip. Although the device 126 is shown attachable to the visor, it could in other implementations be attached to the dash or other portion of the vehicle, such as using an adhesive or the like. In implementations the transcription may be done using device 122, such as through APPLE's SIRI or the like, or the transcription may occur remotely using an AMAZON or GOOGLE transcription service.

In some implementations a user may double-click the business selector after the chime to copy the business purpose from the last trip. In other implementations selecting the business selector a certain number of times may toggle between businesses. In implementations, in order to maintain battery life the device 126 turns on five seconds out of every minute to check for proximity with the device 126 and the battery lasts about a month. In other implementations a wired version could for example use the cigarette lighter or other power source of the vehicle for power. In implementations device 126 may pass the audio directly to device 122 so that the audio is not recorded on device 126 but is recorded initially on device 122. This may be useful, for example, for free transcription services which can be used for live audio on ANDROID devices, but which are not free for recorded audio.

In implementations of another system the device 126 may simply interface with the speakers/microphones of the vehicle itself to provide audio notifications to the user and/or to receive an audio business purpose to be recorded. In other implementations the selection of the business or personal selector may initiate recording using the device 122 itself or recording by a vehicle audio input, so that device 122 just controls functions of the phone or vehicle itself for recording audio. In implementations the system may upload the audio file from the device 122 to remote servers for transcribing (such as AWS servers), and then the audio file and transcription are saved in the data store (such as in one or more cloud databases), and the app on device 122 is updated to include the transcription as the description, but the audio file may only be stored in the data store unless the user accesses the audio file through a web interface or the app to listen to it again (which could be done from device 122). In some implementations the app of device 122 could include a link to the stored audio file so that, if the user desires to listen to the audio file through the app, this can be done.

In some implementations the system may be able to do a “session” whereby, after the user has classified a trip (and provided a business purpose if necessary), device 122 and/or device 126 queries the user regarding unclassified expenses, for example asking “Yesterday you spent $16.84 at Chili's, was this a personal or a business expense?” and then, if it is a business expense (indicated by the user selecting the business selector or speaking the word “business”), following that up with a request to dictate a business purpose, so that the system helps the user to classify and give descriptions for expenses while the user is driving. Although this may distract the driver some, the system could be configured to use audio input from the driver instead of requiring selection of the business or personal selector during the session, so that the user's eyes can remain on the road the entire time.

FIG. 38 discloses a process flow of steps included in a representative method of using the trip classifying system and device, which steps have already been described previously.

As described above, there are useful reasons for simplifying a trip classifying device so that it does not distract a driver any more than is needed, to reduce distraction and reduce vehicle accidents, vehicle damage, injury, and related vehicle deaths. Accordingly, the trip classifying device may be configured so that it has no mechanism to initiate an audio recording except the automatic recording that begins when the user classifies a trip as a business trip. This simplifies the classification by requiring only one selection, and reduces driver distraction. Similarly, the trip classifying device may have no selector configured to manually stop the audio recording. Rather, the audio is recorded for a preset amount of time, such as 10 seconds, 15 seconds, 20 seconds, or some other value, and then automatically stops. This again reduces distraction to the driver, as the driver does not have to manually stop the recording, which may require looking at the device and taking the user's eyes off the road. Further, the trip classifying device may provide no visual indication to the user of whether the trip has been classified as a business or personal trip. If the device includes a visual indicator, indicating whether the trip has been classified as business or personal, this may increase distraction to the driver—it is one more thing for the driver to observe and check. The trip classifying device may, similarly, have no mechanism (or may not be configured) to play back the audio recording. This again reduces distraction to the driver—the driver just speaks the description once and is not distracted by having the option of listening to the recording and/or re-recording. The device also has dedicated business and personal selectors—the selectors are not configurable to represent something else. For example in some prior art devices a business selector may be configured to represent something else, such as a charity selector or a personal selector. This may increase options but it also increases complexity and can add to further driver distraction, vehicle accidents, and so forth. Accordingly, with the trip classifying devices disclosed herein the selectors are dedicated selectors—only a business selector and a personal selector—and cannot be changed to represent anything else. The trip classifying device may also initiate no audio recording if the trip is a personal trip. This may further help to reduce driver distraction and accidents—when the trip is personal no “business purpose” needs to be recorded so an automatic recording may not be done, to reduce driver distraction and increase road safety.

It is also useful that none of the method steps that occur during the trip require user interaction with the mobile device. For example, the steps of receiving the signal at the wireless communication module from the mobile phone, transmitting the audio recording to the mobile phone, and initiating transcription of the audio recording using the software application installed on the mobile phone, do not require user interaction with the mobile phone. Similarly, the step of storing the transcription in memory of the mobile device and/or in one or more data stores does not require user interaction with the mobile phone. Finally, the steps of storing the mileage, the starting location, the ending location, and the date, in memory of the mobile device and/or in a remote data store, do not require user interaction with the mobile phone. The ability to do all these steps without user interaction with the mobile phone reduces user distraction, vehicle accidents, vehicle damage, injury, death, and helps a user be compliant with state laws regarding not using a phone while driving.

The trip classifying device is also simple in that it needs no GPS sensor/module itself, being able to rely on the mobile device's GPS sensor. This is useful to lower the cost, size and complexity of the trip classifying device.

As indicated above, in implementations the systems, devices and methods disclosed herein allow a user to prepare IRS-compliant records of business trips (including starting location, ending location, date, time, mileage, vehicle, business, and business purpose) while the user is still driving, so that each trip is pre-classified before the trip is complete. As also indicated above, the systems, devices and methods may, in implementations, be able to automatically fill in a purpose of a trip using an entry from the user's calendar. For example, the user may have a GOOGLE CALENDAR app installed on the mobile device, and an event or appointment titled “Lunch with Bob Jones to discuss construction contract” may be scheduled on Tuesday at noon. On Tuesday around noon the user may start driving and the device 126 may remind the user to classify the trip as personal or business. The user may select the business selector but, if the user does not record a business purpose while the microphone is being used to record audio, or if the audio cannot successfully be transcribed, the user interfaces of the app (and/or website user interfaces) may show the calendar event title instead, so that the business purpose stored in the data store and/or locally on device 122 is “Lunch with Bob Jones to discuss construction contract.” Alternatively, the user interface(s) may show the user a transcribed business purpose and, additionally, a separate business purpose taken from the calendar, and may allow the user to select, on the user interface(s) which one to keep. Before the user has selected which to keep, both may be stored in the data store and/or locally on device 122. The software app installed on the mobile device 122 which facilitates the methods disclosed herein may extract information from the user's calendar through app-to-app interactions, or using an application programming interface (API) to access the user's calendar on an app or a website, or the like.

Notwithstanding the above, in implementations trip classifying devices may include more than one indicator light, for example an indicator light for power, an indicator light for recording, an indicator light for which classification has been selected (P or B), and so forth, keeping in mind that while such additional indicator lights do add some functionality to the device, there are pros and cons in that they may also increase the amount of time a user needs to spend looking at the device while driving, and thus could have some downsides as discussed above. Even so, they have the upside of increasing the amount of information that is provided to a user.

Similarly, in implementations more than two selectors could be included on the trip classifying device. For example a third charity selector could be included to indicate a charity-related trip, a fourth selector could be included to indicate moving mileage (i.e., a business move), or the selectors could be configured so that they are editable (for example three selectors and each is configurable to represent business mileage, personal mileage, charity mileage, moving mileage, or some custom category of mileage). Even so, there are pros and cons to having additional selectors. While it does add functionality to the device and may allow for more specific capturing of trip information, it can also require the driver to spend more time looking at the device while driving, and thus could have some downsides as discussed above.

Additionally, although the trip classifying device is disclosed herein as not having a playback option, in implementations it could have a playback option so that the user could review what the recording sounds like, and the user may have the option of re-recording the business (or other) purpose if desired. This functionality could be accomplished with the same selector (for example a long press of the business selector may re-initiate recording to overwrite the prior recording) or an additional selector could be included for this purpose. Nevertheless, there are pros and cons to having this functionality and to having additional selectors. While it does increase the ability of the user to record the specific business purpose again in case a mistake was made, it may also increase the amount of time that the user spends engaged with the trip classifying device, and so could lead to additional distraction and the potential downsides discussed above. Even so, such functions may be included if it is desirable to have the option to review and/or re-record a business purpose.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of trip classifying devices, systems and methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited in the claim, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Finally, in places where a claim below uses the term “first” as applied to an element, this does not imply that the claim requires a second (or more) of that element—if the claim does not explicitly recite a “second” of that element, the claim does not require a “second” of that element.

What is claimed is:

1. A trip classifying device, comprising:
a housing;
a processor located at least partly within the housing;
a wireless communication module located at least partly within the housing and communicatively coupled with the processor, wherein the wireless communication module is configured to receive a signal, from a mobile device communicatively coupled with the wireless communication module, indicating that a trip has begun;
a speaker located at least partly within the housing and configured to, in response to the signal being received by the wireless communication module, provide an audio notification to a driver of a vehicle reminding the driver to classify the trip;
a business selector configured to receive a user selection classifying the trip as a business trip;
a personal selector configured to receive a user selection classifying the trip as a personal trip; and
a microphone located at least partly within the housing and communicatively coupled with the processor;
wherein the trip classifying device comprises no trip classifying selectors other than the business selector and the personal selector;
wherein the trip classifying device comprises either zero indicator lights or only one indicator light;
wherein the trip classifying device comprises no electronic display;
wherein the trip classifying device is configured to, in response to receiving the user selection of the business selector, automatically initiate an audio recording, using the microphone, for a predetermined amount of time, for the driver to dictate a business purpose for the trip; and
wherein the trip classifying device is configured to transmit the audio recording to the mobile device to initiate transcription of the audio recording.

2. The trip classifying device of claim 1, wherein the trip classifying device comprises only one indicator light, the only one indicator light comprising a classification reminder indicator light configured to provide a visual notification reminding the driver to classify the trip as a personal trip or a business trip.

3. The trip classifying device of claim 1, wherein the trip classifying device comprises only one indicator light, the only one indicator light comprising a recording indicator light configured to provide a visual notification to the driver when audio is being recorded.

4. The trip classifying device of claim 1, wherein the trip classifying device comprises zero indicator lights.

5. The trip classifying device of claim 1, wherein the trip classifying device is not configured to initiate an audio recording except in response to the user selection of the business selector classifying the trip as a business trip.

6. The trip classifying device of claim 1, wherein the trip classifying device does not comprise a selector configured to manually stop the audio recording.

7. The trip classifying device of claim 1, wherein the trip classifying device does not comprise a global positioning system (GPS) sensor.

8. The trip classifying device of claim 1, wherein the trip classifying device provides no visual indication of whether the trip has been classified as a business trip or a personal trip.

9. The trip classifying device of claim 1, wherein the trip classifying device is not configured to play back the audio recording.

10. The trip classifying device of claim 1, wherein the business selector is not configured to be modified to classify the trip as something other than a business trip, and wherein the personal selector is not configured to be modified to classify the trip as something other than a personal trip.

11. A trip classifying system, comprising:
one or more servers communicatively coupled with a mobile phone through a telecommunication network;
one or more data stores communicatively coupled with the one or more servers;
a trip classifying device communicatively coupled with the mobile phone, the trip classifying device comprising:
a housing;
a processor located at least partly within the housing;
a wireless communication module located at least partly within the housing and communicatively coupled with the processor, wherein the wireless communication module is configured to receive a signal, from the mobile phone, indicating that a trip has begun;
a speaker located at least partly within the housing and configured to, in response to the signal being received by the wireless communication module, provide an audio notification to a driver of a vehicle reminding the driver to classify the trip;
a business selector configured to receive a user selection classifying the trip as a business trip;
a personal selector configured to receive a user selection classifying the trip as a personal trip; and
a microphone located at least partly within the housing and communicatively coupled with the processor;
wherein the trip classifying device comprises no trip classifying selectors other than the business selector and the personal selector;
wherein the trip classifying device comprises no electronic display;
wherein the trip classifying device is configured to, in response to receiving the user selection of the business selector, automatically initiate an audio recording, using the microphone, for a predetermined amount of time, for the driver to dictate a business purpose for the trip;
wherein the trip classifying device is configured to transmit the audio recording to the mobile phone to initiate transcription of the audio recording; and
wherein the one or more servers are configured to provide one or more user interfaces to be displayed on the mobile phone, the one or more user interfaces displaying a transcription of the audio recording.

12. The trip classifying system of claim 11, further comprising a coupler coupled with the housing and configured to attach the trip classifying device to a portion of the vehicle.

13. The trip classifying system of claim 11, wherein the personal selector comprises a first color and wherein the business selector comprises a second color different than the first color.

14. A trip classifying method, comprising:
providing one or more servers;
providing one or more data stores communicatively coupled with the one or more servers;
providing one or more user interfaces to be displayed on a mobile phone communicatively coupled, through a telecommunication network, with the one or more servers;
providing a trip classifying device configured to communicatively couple with the mobile phone, the trip classifying device comprising:
a housing;
a processor located at least partly within the housing;
a wireless communication module located at least partly within the housing and communicatively coupled with the processor;
a speaker located at least partly within the housing;
a business selector configured to receive a user selection classifying a trip as a business trip;
a personal selector configured to receive a user selection classifying the trip as a personal trip; and
a microphone located at least partly within the housing and communicatively coupled with the processor;
receiving a signal, at the wireless communication module, from the mobile phone, indicating that the trip has begun;
in response to receiving the signal at the wireless communication module, providing, using the trip classifying device, one of a visual notification and an audio notification to a driver of a vehicle, reminding the driver to classify the trip;
in response to receiving the user selection of the business selector, automatically initiating, with the processor and using the microphone, an audio recording, for a predetermined amount of time, for the driver to dictate a business purpose for the trip;
transmitting the audio recording to the mobile phone;
using a software application installed on the mobile phone, initiating transcription of the audio recording; and
displaying, on the one or more user interfaces, a transcription of the audio recording.

15. The trip classifying method of claim 14, further comprising, in response to receiving the user selection of the personal selector, not initiating an audio recording.

16. The trip classifying method of claim 14, wherein the trip classifying device comprises no trip classifying selectors other than the business selector and the personal selector, wherein the trip classifying device comprises either zero indicator lights or only one indicator light, and wherein the trip classifying device comprises no electronic display.

17. The trip classifying method of claim 14, wherein the predetermined amount of time is less than 20 seconds.

18. The trip classifying method of claim 14, wherein the steps of receiving the signal at the wireless communication module from the mobile phone, transmitting the audio recording to the mobile phone, and initiating transcription of the audio recording, do not require user interaction with the mobile phone.

19. The trip classifying method of claim 14, further comprising storing the transcription in one of a memory of the mobile phone and the one or more data stores, wherein the step of storing the transcription does not require user interaction with the mobile phone.

20. The trip classifying method of claim 14, further comprising storing a mileage of the trip, a starting location of the trip, an ending location of the trip, and a date of the trip, in one of a memory of the mobile phone and the one or more data stores, wherein the steps of storing the mileage, the starting location, the ending location, and the date do not require user interaction with the mobile phone.
